(19) United States
(12) Patent Application Publication
(10) Pub. No.: US 2026/0077884 A1
(43) Pub. Date: Mar. 19, 2026

(54) SPACE ELECTRIC PROPULSION SYSTEM AND XENON FILLING METHOD THEREFOR

(71) Applicant: SHANGHAI INSTITUTE OF SPACE PROPULSION, Shanghai (CN)

(72) Inventors: Xiqiao Yu, Shanghai (CN); Bo Zhang, Shanghai (CN); Nan Li, Shanghai (CN); Jiachen Zhao, Shanghai (CN); Xing Chen, Shanghai (CN); Huiguang Zhao, Shanghai (CN)

(21) Appl. No.: 19/109,998

(22) PCT Filed: Dec. 25, 2023
(86) PCT No.: PCT/CN2023/141436

§ 371 Date: Mar. 7, 2025

(30) Foreign Application Priority Data
May 17, 2023 (CN) 202310559653.2

(51) Int. Cl. B64G 1/40; F17C 5/00

(52) U.S. Cl. CPC B64G 1/411; B64G 1/4021; F17C 5/002; F17C 2205/0326; F17C 2221/016; F17C 2227/0302; F17C 2227/0337; F17C 2250/0421; F17C 2250/043; F17C 2250/0636; F17C 2250/0694; F17C 2265/066; F17C 2270/0197

(57) ABSTRACT

A space electric propulsion system and a xenon filling method therefor are provided, suitable for a filling process of an electric propulsion system using high-purity xenon as a working medium. By reasonably designing a filling process, the precision of a xenon filling amount is ensured, and xenon filling can be performed without weighing the whole spacecraft. This method features a simple and efficient filling device, short preparation time, precise and controllable filling process, as well as safety and convenience, which can effectively meet the requirements for a high-purity xenon rapid filling task of a satellite.

### TECHNICAL FIELD

The present disclosure relates to the technical field of space electric propulsion, and in particular to a xenon filling method for a space electric propulsion system.

### BACKGROUND

The electric propulsion system is widely used in spacecraft, and its functions are north-south position maintenance, attitude control, orbit control and orbit transfer of the spacecraft. At present, the mainstreaming xenon filling scheme for the electric propulsion system is a thermal pressurization filling scheme. This filling process typically involves weighing the onboard xenon tanks to control the amount of xenon filled. Since the xenon tanks of the electric propulsion system are often coupled with the satellite's cabin structure, and xenon filling is usually conducted in the final stages before the satellite's launch, the satellite has already completed all assembly by this stage. Therefore, weighing the entire satellite is necessary for xenon filling. For spacecraft of different configurations, specialized adapters need to be designed to place the satellite on an electronic scale, or the entire satellite must be hoisted for weighing. However, it is challenging to weigh large spacecraft entirely. Moreover, the amount of xenon filled is relatively small compared to the total mass of the satellite, which imposes high requirements on the range and precision of the electronic scale.

The inventors believe that the existing xenon filling method relies too much on the whole spacecraft weighing equipment, which is not conducive to the rapid preparation of filling operations. Therefore, a rapid xenon filing method needs to be provided, making the xenon filling no longer depend on the weighing of the whole spacecraft, and the method has the advantages such as simple and efficient filling device, short filling preparation time, precisely controllable xenon filling process, as well as safety and convenience, and can effectively meet the requirements for a high-purity xenon rapid filling task of a satellite.

### SUMMARY

For the defects in the prior art, an objective of the present disclosure is to provide a space electric propulsion system and xenon filling method therefor.

A space electric propulsion system provided by the present disclosure includes a xenon storage tank, a gas source valve, a thermal pressurizer, an electronic scale of the thermal pressurizer, a liquid nitrogen valve, a liquid nitrogen tank, a pressure gauge of the thermal pressurizer, an outlet valve of the thermal pressurizer, a vacuum pump, a vacuum valve, a cooling device, a pressure gauge at an inlet of an onboard xenon tank, a filling valve, and the onboard xenon tank.

The xenon storage tank is connected to the thermal pressurizer through the gas source valve, the electronic scale of the thermal pressurizer is configured to weigh the thermal pressurizer, the pressure gauge of the thermal pressurizer and the outlet valve of the thermal pressurizer are arranged at an outlet of the thermal pressurizer, the liquid nitrogen tank is connected to the thermal pressurizer through the liquid nitrogen valve, the onboard xenon tank is connected to the cooling device through the filling valve, the pressure gauge at the inlet of the onboard xenon tank is arranged at an inlet of the filling valve, the vacuum pump is connected to the cooling device through the vacuum valve, and the vacuum pump is connected to the thermal pressurizer through the vacuum valve.

The present disclosure further provides a xenon filling method for a space electric propulsion system. The method is applied to the space electric propulsion system described above, and includes the following steps:
S1: after the onboard xenon tank is replaced and purity of xenon achieves a desired requirement, turning on the vacuum pump, opening the vacuum valve and the filling valve, closing the outlet valve of the thermal pressurizer, and vacuumizing the onboard xenon tank and a pipeline at a rear end of the outlet valve of the thermal pressurizer to prepare for xenon filling;
S2: opening the gas source valve to fill the xenon in the xenon storage tank into the thermal pressurizer;
S3: opening the outlet valve of the thermal pressurizer, closing the filling valve of the onboard xenon tank, observing the pressure gauge at the inlet of the onboard xenon tank, and filling a preset amount of the xenon into a pipeline of a filling device;
S4: heating high-pressure xenon in the thermal pressurizer, and when a pressure of the pressure gauge of the thermal pressurizer is higher than a pressure of the pressure gauge at the inlet of the onboard xenon tank, opening the outlet valve of the thermal pressurizer and the filling valve of the onboard xenon tank to fill the onboard xenon tank, when a reading of the electronic scale of the thermal pressurizer continuously drops to approach W0, stopping heating and closing the outlet valve of the thermal pressurizer, and recording the reading V1 of the electronic scale of the thermal pressurizer at this time, where a xenon filling amount R1 of the onboard xenon tank at this time is as follows: R1=W1−V1;
S5: repeating S2 and S4 until the xenon filling amount R1 approaches and is less than a required value E;
S6: closing the filling valve of the onboard xenon tank, recording the reading U1 of the electronic scale of the thermal pressurizer at this time, recording a reading P1 of the pressure gauge at the inlet of the onboard xenon tank; when monitoring that the pressure gauge at the inlet of the onboard xenon tank no longer changes within specified time T2, confirming that a gas temperature in a pipeline is constant at a preset temperature T0; opening the outlet valve of the thermal pressurizer and the liquid nitrogen valve, and drawing the xenon in the pipeline of the filling device back into the thermal pressurizer;
S7: calculating a xenon target value U3 of a thermal pressurization tank: U3=(E−R2)+U2+W0a, opening the gas source valve and the liquid nitrogen valve, and drawing the xenon from the xenon storage tank into the thermal pressurizer and weighing; closing the gas source valve and the liquid nitrogen valve when an intake amount reaches the xenon target value U3; after the valves are closed, enabling the thermal pressurizer to stand for specified time T1 to wait for complete gasification of liquid nitrogen, and observing the electronic scale of the thermal pressurizer during the specified time T1; and
S8: heating the high-pressure xenon in the thermal pressurizer, and when a pressure in the thermal pressurizer is higher than the reading P1 of the pressure gauge at the inlet of the onboard xenon tank, opening the outlet valve of the thermal pressurizer, and opening the filling valve of the onboard xenon tank for filling; when the reading of the electronic scale of the thermal pressurizer continuously drops to U1, stopping heating, and closing the outlet valve of the thermal pressurizer and the filling valve of the onboard xenon tank, thus completing the xenon filling.

In some embodiments, S1 includes: turning on the cooling device, setting a temperature control of the pipeline in the filling device to T0, and recording an initial reading W0 of the electronic scale of the thermal pressurizer.

In some embodiments, S2 includes: when a pressure between the xenon storage tank and the thermal pressurizer has equalized, opening the liquid nitrogen valve, and drawing the xenon from the xenon storage tank into the thermal pressurizer by utilizing physical characteristics of the xenon, and then weighing the thermal pressurizer; when the intake amount reaches the required value, closing the gas source valve and the liquid nitrogen valve; after the valves are closed, enabling the thermal pressurizer to stand for the specified time T1 to wait for the complete gasification of the liquid nitrogen, and observing the reading of the electronic scale of the thermal pressurizer during the specified time T1; if the reading of the electronic scale of the thermal pressurizer no longer changes within the specified time T1, confirming that the liquid nitrogen is completely gasified, and recording the reading W1 of the electronic scale of the thermal pressurizer at this time, where for a first filling transfer, the reading of the electronic scale of the thermal pressurizer is W1; for a second filling transfer, the reading of the electronic scale of the thermal pressurizer is W2 . . . and so on, and for an nth filling transfer, the reading of the electronic scale of the thermal pressurizer is Wn.

In some embodiments, S3 includes: after the filling is completed, recording the reading W1b of the electronic scale of the thermal pressurizer, where a preset xenon weight W0a in the pipeline of the filling device is as follows: W0a=W1−W1b.

In some embodiments, in S3, a preset pressure value for filling the xenon is P0.

In some embodiments, in S4, for a first filling, the reading of the electronic scale of the thermal pressurizer is V1; for a second filling, the reading of the electronic scale of the thermal pressurizer is V2 . . . and so on; for an nth filling, the reading of the electronic scale of the thermal pressurizer is Vn; and the xenon filling amount R1 of the onboard xenon tank is as follows: R1=(W1−V1)+(W2−V2). . . +(Wn−Vn).

In some embodiments, S6 includes: when the pressure gauge at the inlet of the onboard xenon tank is equal to a preset pressure valve P0, closing the liquid nitrogen valve and the outlet valve of the thermal pressurizer; if the reading of the electronic scale of the thermal pressurizer no longer changes within the specified time T1, confirming that the liquid nitrogen is completely gasified, and recording the reading U2 of the electronic scale of the thermal pressurizer at this time, where a xenon filling amount R2 of the onboard xenon tank is as follows: R2=(W1−V1)+(W2−V2) . . . +(Wn−Vn)−(U2−U1)−W0a.

In some embodiments, S6 includes conforming that a temperature control of a pipeline in the cooling device is set to T0.

In some embodiments, S7 includes: conforming that the liquid nitrogen is completely gasified if the reading of the electronic scale of the thermal pressurizer no longer changes with the specified time T1, and recording the reading M1 of the electronic scale of the thermal pressurizer at this time; if an error value of |M1−U3| is within an acceptable level, turning to S6; if the error value is large, repeating S5 until the reading M1 reaches the xenon target value U3.

Compared with the prior art, the present disclosure has the following beneficial effects:
1. By reasonably designing a filling method, on the premise of guaranteeing the accuracy of the xenon filling amount, the xenon filling can be carried out without depending on the weighing of whole spacecraft, and such a method is applicable to satellites that cannot be weighed for the whole spacecraft.
2. By reasonably designing the filling method, the xenon filling device is simplified, the manufacturing cost of the xenon filling device is reduced, the security and reliability of the xenon filling process are still guaranteed, and the filling method has high operability.
3. According to the xenon filling method provided by the present disclosure, a filling weight error thereof mainly depends on a measurement error of the electronic scale and a residual weight error of the gas in the xenon filling device. The measurement error of electronic scale is a systematic error, which cannot be eliminated by all xenon filling methods. By accurately controlling the temperature and calibrating the weight of the gas in the internal pipeline of the xenon filling device, the residual weight error of the gas in the xenon filling device can be eliminated to guarantee that the xenon filling amount is accurate and controllable. Moreover, such a calibration only needs to be carried out once for the same xenon filling device, there is no need to repeat the calibration, so that the xenon filling process is simplified.

### BRIEF DESCRIPTION OF THE DRAWINGS

Other features, objectives and advantages of the present disclosure will become more apparent by reading the detailed description of non-limiting embodiments with reference to the following drawings.

FIG. 1 is a schematic diagram of composition of a xenon filling device according to an embodiment of the present disclosure; and

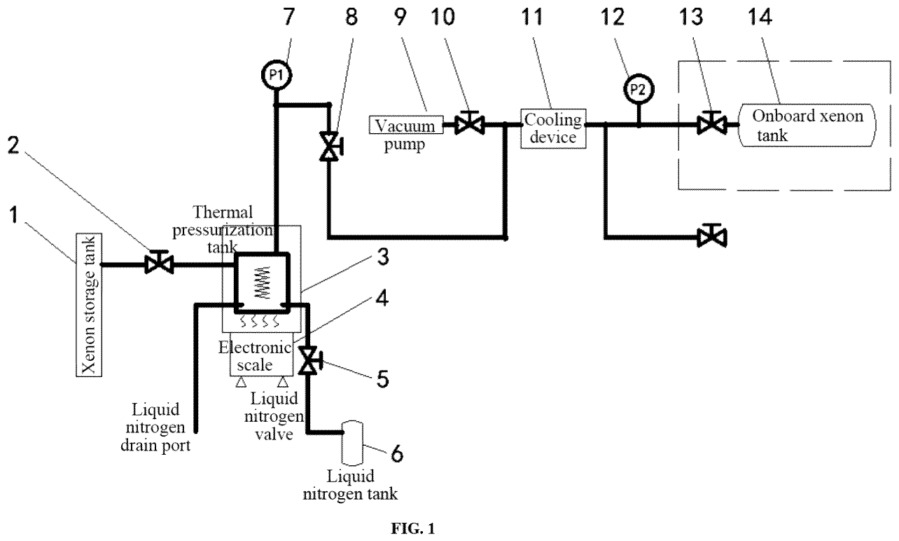

FIG. 2 is a flowchart of a xenon filling method according to an embodiment of the present disclosure.

In the drawings:
1 xenon storage tank; 2 gas source valve; 3 thermal pressurizer; 4 electronic scale of thermal pressurizer; 5 liquid nitrogen valve; 6 liquid nitrogen tank; 7 pressure gauge of thermal pressurizer; 8 outlet valve of thermal pressurizer; 9 vacuum pump; 10 vacuum valve; 11 cooling device; 12 pressure gauge at inlet of onboard xenon tank; 13 filling valve; 14 onboard xenon tank.

### DETAILED DESCRIPTION OF THE EMBODIMENTS

The present disclosure is further described below with reference to specific embodiments. The following embodiments will help those skilled in the art to further understand the present disclosure, but do not limit the present disclosure in any way. It should be noted that for those of ordinary skill in the art, multiple changes and improvements can be made without departing from the concept of the present disclosure, all of which fall within the scope of protection of the present disclosure.

### Embodiments

A space electric propulsion system provided by the present disclosure includes a xenon storage tank 1, a gas source valve 2, a thermal pressurizer 3, an electronic scale 4 of the thermal pressurizer, a liquid nitrogen valve 5, a liquid nitrogen tank 6, a pressure gauge 7 of the thermal pressurizer, an outlet valve 8 of the thermal pressurizer, a vacuum pump 9, a vacuum valve 10, a cooling device 11, a pressure gauge 12 at an inlet of an onboard xenon tank, a filling valve 13, and the onboard xenon tank 14. The xenon storage tank 1 is connected to the thermal pressurizer 3 through the gas source valve 2, the electronic scale 4 of the thermal pressurizer is configured to weigh the thermal pressurizer 3, the pressure gauge 7 of the thermal pressurizer and the outlet valve 8 of the thermal pressurizer are arranged at an outlet of the thermal pressurizer 3, and the liquid nitrogen tank 6 is connected to the thermal pressurizer 3 through the liquid nitrogen valve 5. The onboard xenon tank 14 is connected to the cooling device 11 through the filling valve 13, and the pressure gauge 12 at the inlet of the onboard xenon tank is arranged at an inlet of the filling valve 13. The vacuum pump 9 is connected to the cooling device 1 through the vacuum valve 10, and the vacuum pump 9 is connected to the thermal pressurizer 3 through the vacuum valve 10.

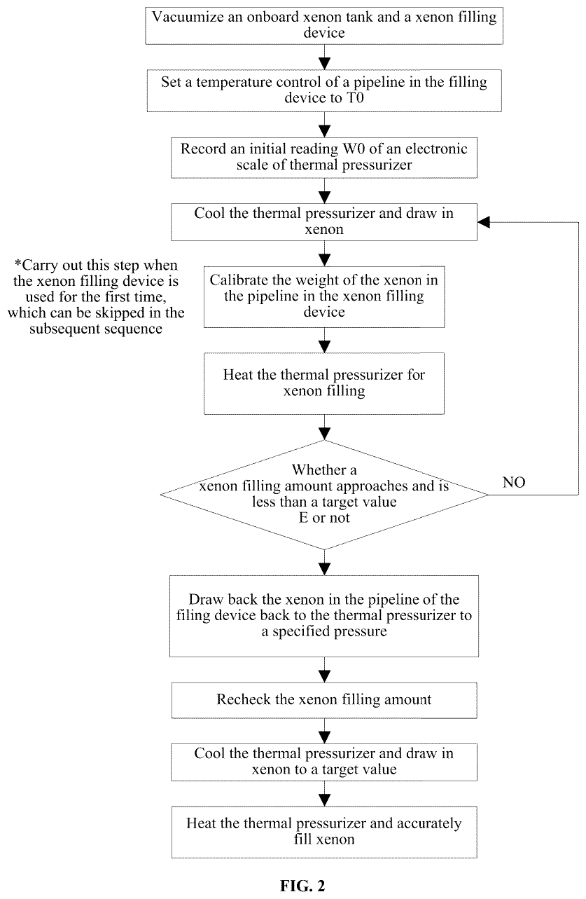

The present disclosure further provides a xenon filling method for a space electric propulsion system, which is applied to the space electric propulsion system described above. The method is shown in FIG. 2 and includes the following steps.
S1: after the onboard xenon tank 14 is replaced and purity of xenon achieves a desired requirement, the vacuum pump 9 is turned on, the vacuum valve 10 is opened, the filling valve 13 is opened, the outlet valve 8 of the thermal pressurizer is closed, and the onboard xenon tank 14 and a pipeline at a rear end of the outlet valve 8 of the thermal pressurizer are vacuumized to prepare for xenon filling; the cooling device 11 is turned on, and a temperature control of a pipeline in a filling device is set to T0, and an initial reading W0 of the electronic scale 4 of the thermal pressurizer is recorded.
S2: a gas source valve 2 is opened to fill the xenon in the xenon storage tank 1 into the thermal pressurizer 3; when the pressure between the xenon storage tank and the thermal pressurizer has equalized, the liquid nitrogen valve 5 is opened, and the xenon is drawn from the xenon storage tank 1 into the thermal pressurizer 3 by utilizing physical characteristics of the xenon, and then weighing is carried out; when the intake amount reaches the required value, the gas source valve 2 and the liquid nitrogen valve 5 are closed; after the valves are closed, the thermal pressurizer is allowed to stands for specified time T1 to wait for complete gasification of the liquid nitrogen, and the reading of the electronic scale 4 of the thermal pressurizer is observed during the specified time T1; if the reading of the electronic scale 4 of the thermal pressurizer no longer changes within the specified time T1, it is confirmed that the liquid nitrogen is completely gasified, and at this time, the reading W1 of the electronic scale 4 of the thermal pressurizer is recorded. For a first filling transfer, the reading of the electronic scale 4 of the thermal pressurizer is W1; for a second filling transfer, the reading of the electronic scale 4 of the thermal pressurizer is W2 . . . and so on, and for an nth filling transfer, the reading of the electronic scale 4 of the thermal pressurizer is Wn.
S3: the outlet valve 8 of the thermal pressurizer is opened, the filling valve 13 of the onboard xenon tank 14 is closed, the pressure gauge 12 at the inlet of the onboard xenon tank is observed, and the preset amount of the xenon is filled into the pipeline of the filling device; after the filling is completed, the reading W1b of the electronic scale 4 of the thermal pressurizer is recorded, the preset xenon weight W0a of the pipeline of the filling device is as follows: W0a=W1−W1b, and a preset pressure value for filling the xenon is P0.
S4: high-pressure xenon in the thermal pressurizer 3 is heated, and when the pressure of the pressure gauge 7 of the thermal pressurizer is higher than that of the pressure gauge 12 at the inlet of the onboard xenon tank, the outlet valve 8 of the thermal pressurizer and the filling valve 13 of the onboard xenon tank 14 are opened to fill the onboard xenon tank 14; when the reading of the electronic scale 4 of the thermal pressurizer continuously drops to approach W0, heating is stopped, and the outlet valve 8 of the thermal pressurizer is closed; the reading V1 of the electronic scale 4 of the thermal pressurizer at this time is recorded, and at this time, the xenon filling amount R1 of the onboard xenon tank 14 is as follows: R1=W1−V1. For the first filling, the reading of the electronic scale 4 of the thermal pressurizer is V1; for the second filling, the reading of the electronic scale 4 of the thermal pressurizer is V2 . . . and so on, for the nth filling, the reading of the electronic scale 4 of the thermal pressurizer is Vn, and the xenon filling mount R1 of the onboard xenon tank 14 is as follows: R1=W1−V1+W2−V2. . . +(Wn−Vn).
S5: S2 and S4 are repeated until the xenon filling amount R1 approaches and is less than a required value E.
S6: the filling valve 13 of the onboard xenon tank 14 is closed, the reading U1 of the electronic scale 4 of the thermal pressurizer at this time is recorded, and a reading P1 of the pressure gauge 12 at the inlet of the onboard xenon tank is recorded; when monitoring that the pressure gauge 12 at the inlet of the onboard xenon tank no longer changes within specified time T2, it is confirmed that a gas temperature in the pipeline is constant at a preset temperature T0; the outlet valve 8 of the thermal pressurizer and the liquid nitrogen valve 5 are opened, and the xenon in the pipeline of the filling device is drawn back into the thermal pressurizer 3; when the pressure gauge 12 at the inlet of the onboard xenon tank is equal to the preset pressure value P0, the liquid nitrogen valve 5 and the outlet valve 8 of the thermal pressurizer are closed; if the reading of the electronic scale 4 of the thermal pressurizer no longer changes within the specified time T1, it is confirmed that the liquid nitrogen is completely gasified, and the reading U2 of the electronic scale 4 of the thermal pressurizer at this time is recorded; the xenon filling amount R2 of the onboard xenon tank 14 is as follows: R2=W1−V1+W2−V2. . . +(Wn−Vn)−(U2−U1)−W0a, and it is confirmed that the temperature control of the pipeline in the cooling device is set to T0.
S7: a xenon target value U3 of a thermal pressurization tank is calculated: U3=(E−R2)+U2+W0a, the gas source valve 2 and the liquid nitrogen valve 5 are opened, and the xenon is drawn from the xenon storage tank 1 into the thermal pressurizer 3, and weighing is carried out; when an intake amount reaches the xenon target value U3, the gas source valve 2 and the liquid nitrogen valve 5 are closed; after the valves are closed, the thermal pressurizer is allowed to stands for the specified time T1 to wait for the complete gasification of the liquid nitrogen, and the electronic scale 4 of the thermal pressurizer is observed during the specified time T1; if the reading of the electronic scale 4 of the thermal pressurizer no longer changes within the specified time T1, it is confirmed that the liquid nitrogen is completely gasified, and the reading M1 of the electronic scale 4 of the thermal pressurizer at this time is recorded, if an error value of |M1−U3| is within an acceptable level, turn to S6; if the error value is large, S5 is repeated until the reading M1 reaches the xenon target value U3.
S8: the high-pressure xenon in the thermal pressurizer 3 is heated, and when the pressure in the thermal pressurizer 3 is higher than the reading P1 of the pressure gauge 12 at the inlet of the onboard xenon tank, the outlet valve 8 of the thermal pressurizer is opened and the filling valve 13 of the onboard xenon tank 14 is opened for filling; when the reading of the electronic scale 4 of the thermal pressurizer continuously drops to U1, heating is stopped, and the outlet valve 8 of the thermal pressurizer and the filling valve 13 of the onboard xenon tank 14 are closed, thus completing the xenon filling.

In the description of the present disclosure, it should be understood that the orientation or positional relationship indicated by terms “upper”, “lower”, “front”, “back”, “left”, “right”, “vertical”, “horizontal”, “top”, “bottom”, “inside” and “outside” is based on the orientation or positional relationship shown in the accompanying drawings only for convenience of description of the present disclosure and simplification of description rather than indicating or implying that the device or element referred to must have a particular orientation, be constructed and operate in a particular orientation, and thus are not to be construed as limiting the present disclosure.

The specific embodiments of the present disclosure are described above. It should be understood that the present disclosure is not limited to the above particular embodiments. Those skilled in the art can make various changes or modifications within the scope of the claims, which does not affect the essential contents of the present disclosure. The embodiments of the present disclosure and features in the embodiments may be combined with each other without causing conflict.

What is claimed is:

1. A space electric propulsion system, comprising a xenon storage tank (1), a gas source valve (2), a thermal pressurizer (3), an electronic scale (4) of the thermal pressurizer, a liquid nitrogen valve (5), a liquid nitrogen tank (6), a pressure gauge (7) of the thermal pressurizer, an outlet valve (8) of the thermal pressurizer, a vacuum pump (9), a vacuum valve (10), a cooling device (11), a pressure gauge (12) at an inlet of an onboard xenon tank, a filling valve (13), and the onboard xenon tank (14);
wherein the xenon storage tank (1) is connected to the thermal pressurizer (3) through the gas source valve (2), the electronic scale (4) of the thermal pressurizer is configured to weigh the thermal pressurizer (3), the pressure gauge (7) of the thermal pressurizer and the outlet valve (8) of the thermal pressurizer are arranged at an outlet of the thermal pressurizer (3), the liquid nitrogen tank (6) is connected to the thermal pressurizer (3) through the liquid nitrogen valve (5), the onboard xenon tank (14) is connected to the cooling device (11) through the filling valve (13), the pressure gauge (12) at the inlet of the onboard xenon tank is arranged at an inlet of the filling valve (13), the vacuum pump (9) is connected to the cooling device (1) through the vacuum valve (10), and the vacuum pump (9) is connected to the thermal pressurizer (3) through the vacuum valve (10).

2. A xenon filling method for a space electric propulsion system, wherein the method is applied to the space electric propulsion system according to claim 1, and comprises the following steps:
S1: after the onboard xenon tank (14) is replaced and purity of xenon achieves a desired requirement, turning on the vacuum pump (9), opening the vacuum valve (10) and the filling valve (13), closing the outlet valve (8) of the thermal pressurizer, and vacuumizing the onboard xenon tank (14) and a pipeline at a rear end of the outlet valve (8) of the thermal pressurizer to prepare for xenon filling;
S2: opening the gas source valve (2) to fill the xenon in the xenon storage tank (1) into the thermal pressurizer (3);
S3: opening the outlet valve (8) of the thermal pressurizer, closing the filling valve (13) of the onboard xenon tank (14), observing the pressure gauge (12) at the inlet of the onboard xenon tank, and filling a preset amount of the xenon into a pipeline of a filling device;
S4: heating high-pressure xenon in the thermal pressurizer (3), and when a pressure of the pressure gauge (7) of the thermal pressurizer is higher than a pressure of the pressure gauge (12) at the inlet of the onboard xenon tank, opening the outlet valve (8) of the thermal pressurizer and the filling valve (13) of the onboard xenon tank (14) to fill the onboard xenon tank (14), when a reading of the electronic scale (4) of the thermal pressurizer continuously drops to approach W0, stopping heating and closing the outlet valve (8) of the thermal pressurizer, and recording the reading V1 of the electronic scale (4) of the thermal pressurizer at this time, wherein a xenon filling amount R1 of the onboard xenon tank (14) at this time is as follows: R1=W1−V1;
S5: repeating S2 and S4 until the xenon filling amount R1 approaches and is less than a required value E;
S6: closing the filling valve (13) of the onboard xenon tank (14), recording the reading U1 of the electronic scale (4) of the thermal pressurizer at this time, recording a reading P1 of the pressure gauge (12) at the inlet of the onboard xenon tank; when monitoring that the pressure gauge (12) at the inlet of the onboard xenon tank no longer changes within specified time T2, confirming that a gas temperature in a pipeline is constant at a preset temperature T0; opening the outlet valve (8) of the thermal pressurizer and the liquid nitrogen valve (5), and drawing the xenon in the pipeline of the filling device back into the thermal pressurizer (3);
S7: calculating a xenon target value U3 of a thermal pressurization tank: U3=(E−R2)+U2+W0a, opening the gas source valve (2) and the liquid nitrogen valve (5), and drawing the xenon from the xenon storage tank (1) into the thermal pressurizer (3) and weighing; closing the gas source valve (2) and the liquid nitrogen valve (5) when an intake amount reaches the xenon target value U3; after the valves are closed, enabling the thermal pressurizer to stand for specified time T1 to wait for complete gasification of liquid nitrogen, and observing the electronic scale (4) of the thermal pressurizer during the specified time T1; and
S8: heating the high-pressure xenon in the thermal pressurizer (3), and when a pressure in the thermal pressurizer (3) is higher than the reading P1 of the pressure gauge (12) at the inlet of the onboard xenon tank, opening the outlet valve (8) of the thermal pressurizer, and opening the filling valve (13) of the onboard xenon tank (14) for filling; when the reading of the electronic scale (4) of the thermal pressurizer continuously drops to U1, stopping heating, and closing the outlet valve (8) of the thermal pressurizer and the filling valve (13) of the onboard xenon tank (14), thus completing the xenon filling.

3. The xenon filling method for a space electric propulsion system according to claim 2, wherein S1 comprises: turning on the cooling device (11), setting a temperature control of the pipeline in the filling device to T0, and recording an initial reading W0 of the electronic scale (4) of the thermal pressurizer.

4. The xenon filling method for a space electric propulsion system according to claim 2, wherein S2 comprises: when a pressure between the xenon storage tank (1) and the thermal pressurizer (3) has equalized, opening the liquid nitrogen valve (5), and drawing the xenon from the xenon storage tank (1) into the thermal pressurizer (3) by utilizing physical characteristics of the xenon, and then weighing the thermal pressurizer (3); when the intake amount reaches the required value, closing the gas source valve (2) and the liquid nitrogen valve (5); after the valves are closed, enabling the thermal pressurizer to stand for the specified time T1 to wait for the complete gasification of the liquid nitrogen, and observing the reading of the electronic scale (4) of the thermal pressurizer during the specified time T1; if the reading of the electronic scale (4) of the thermal pressurizer no longer changes within the specified time T1, confirming that the liquid nitrogen is completely gasified, and recording the reading W1 of the electronic scale (4) of the thermal pressurizer at this time, wherein for a first filling transfer, the reading of the electronic scale (4) of the thermal pressurizer is W1; for a second filling transfer, the reading of the electronic scale (4) of the thermal pressurizer is W2 . . . and so on, and for an nth filling transfer, the reading of the electronic scale (4) of the thermal pressurizer is Wn.

5. The xenon filling method for a space electric propulsion system according to claim 2, wherein S3 comprises: after the filling is completed, recording the reading W1b of the electronic scale (4) of the thermal pressurizer, wherein a preset xenon weight W0a in the pipeline of the filling device is as follows: W0a=W1−W1b.

6. The xenon filling method for a space electric propulsion system according to claim 2, wherein in S3, a preset pressure value for filling the xenon is P0.

7. The xenon filling method for a space electric propulsion system according to claim 2, wherein in S4, for a first filling, the reading of the electronic scale (4) of the thermal pressurizer is V1; for a second filling, the reading of the electronic scale (4) of the thermal pressurizer is V2 . . . and so on; for an nth filling, the reading of the electronic scale (4) of the thermal pressurizer is Vn; and the xenon filling amount R1 of the onboard xenon tank (14) is as follows: R1=(W1−V1)+(W2−V2) . . . +(Wn−Vn).

8. The xenon filling method for a space electric propulsion system according to claim 2, wherein S6 comprises: when the pressure gauge (12) at the inlet of the onboard xenon tank is equal to a preset pressure valve P0, closing the liquid nitrogen valve (5) and the outlet valve (8) of the thermal pressurizer; if the reading of the electronic scale (4) of the thermal pressurizer no longer changes within the specified time T1, confirming that the liquid nitrogen is completely gasified, and recording the reading U2 of the electronic scale (4) of the thermal pressurizer at this time, wherein a xenon filling amount R2 of the onboard xenon tank (14) is as follows: R2=(W1−V1)+(W2−V2) . . . +(Wn−Vn)−(U2−U1)−W0a.

9. The xenon filling method for a space electric propulsion system according to claim 2, wherein S6 comprises conforming that a temperature control of a pipeline in the cooling device

(11) is set to T0.

10. The xenon filling method for a space electric propulsion system according to claim 2, wherein S7 comprises: conforming that the liquid nitrogen is completely gasified if the reading of the electronic scale (4) of the thermal pressurizer no longer changes with the specified time T1, and recording the reading M1 of the electronic scale (4) of the thermal pressurizer at this time; if an error value of |M1−U3| is within an acceptable level, turning to S6; if the error value is large, repeating S5 until the reading M1 reaches the xenon target value U3.
